(19) United States
(12) Patent Application Publication
(10) Pub. No.: US 2007/0136361 A1
(43) Pub. Date: Jun. 14, 2007

(54) Method and apparatus for providing XML signature service in wireless environment

(76) Inventors: Jae Seung Lee, Seoul (KR); Soo Hyung Kim, Daejeon-city (KR); Ki Young Moon, Daejeon-city (KR); Kyo Il Chung, Daejeon-city (KR); Sung Won Sohn, Daejeon-city (KR)

Correspondence Address: LADAS & PARRY LLP, 224 SOUTH MICHIGAN AVENUE, SUITE 1600, CHICAGO, IL, 60604, US

(21) Appl. No.: 11/635,367

(22) Filed: Dec. 7, 2006

(30) Foreign Application Priority Data
Dec. 7, 2005 (KR) 10-2005-0118634
Oct. 9, 2006 (KR) 10-2006-0098096

(51) Int. Cl. G06F 7/00

(52) U.S. Cl. 707/102

(57) ABSTRACT

Provided are a mobile extensible Markup Language (XML) signature service providing apparatus and method. The mobile XML signature service providing apparatus includes: an XML message analyzing unit authenticating a mobile client, according to an XML signature template generation request or an XML signature verification request received from the mobile client; an XML signature processor generating an XML signature template and a SignedInfo element in a canonicalized format if the authentication is successful, and verifying an XML signature; and an encoder providing key information and at least one setting value for the generation of the XML signature template and verification of the XML signature, to the XML signature processor. Therefore, the mobile XML signature service providing apparatus and method provide authentication, integrity, non-repudiation, etc. with respect to messages received/transmitted in a wireless environment, are applied to a wireless environment having limited resources, are compatible with an XML signature for an existing wired environment that is to be applied to wired-and-wireless integration electronic commerce, and minimizes a change in an existing wired environment when a mobile XML signature is applied.

### CROSS-REFERENCE TO RELATED PATENT APPLICATION

This application claims the benefit of Korean Patent Application Nos. 10-2005-0118634 filed on Dec. 7, 2005 and 10-2006-0098096 filed on Oct. 9, 2006, in the Korean Intellectual Property Office, the disclosures of which are incorporated herein in their entirety by reference.

### BACKGROUND OF THE INVENTION

1. Field of the Invention

The present invention relates to an apparatus and method for generating and verifying an extensible Markup Language (XML) signature in a wireless environment.

2. Description of the Related Art

XML documents have become established as standardized electronic documents used in electronic commerce. An XML signature is used to provide authentication, integrity, non-repudiation, etc. for such XML documents.

If an existing electronic signature is applied to an XML document without modification, the XML document to which the existing electronic signature is applied is stored as a binary object. In this case, the XML document is no longer compatible with XML technology, which is a text-based open technology, and an algorithm identifier of the XML document is an object identifier (OID) which cannot be easily recognized. For these reasons, a problem exists in that, when an electronic signature is verified, signature algorithms, information processing of certifications, etc. depend on a specific application.

An XML signature solves such a problem. In this case, a document to which the XML signature is applied is processed as an XML node which is encoded to text, and an algorithm identifier of the document is encoded to a Uniform Resource Name (URN) which can be easily recognized. Also, certification-related information is represented in a format which can be easily recognized, and a signed resource is easily identified, subjected to an XML signature, and processed by a corresponding application, with reference to a Uniform Resource Identifier (URI), an XML link, etc.

The XML signature can be applied to all digital contents as well as XML data. The XML signature can be applied simultaneously to a plurality of resources in order to represent them as an XML signature document. Also, it is possible that the XML signature method is performed on a specific portion of an XML document, as well as on the entire XML document. Accordingly, efficient XML signature processing is possible.

XML signature standardization has been carried out by the W3C XML Signature Working Group and the Internet Engineering Task Force (IETF). XML Signature Syntax and Processing, Canonical XML Version 1.0, Exclusive Canonical XML Version 1.0, etc. are recommended by the W3C XML Signature Working Group.

Since mobile terminals used in wireless environments have many limitations in terms of resources, such as small memory capacity, slow processing speed, etc., they are inappropriate for performing XML document parsing, eXtensible Stylesheet Language Transformations (XSLT) conversion, XPath conversion, XML Canonicalization, etc. required to perform XML signature processing under an existing wired environment. Recently, in wireless Internet platform environments, such as J2ME, BREW, WIPI, etc., electronic signature processing, communication channel encoding such as Wireless Transport Layer Security (WTLS), etc. can be performed. However, the processing speed is low so that all XML signature processing including the above-described processing functions cannot be performed, and it is also difficult to load all libraries related to the XML signature to a mobile terminal. In order to resolve these problems, if functions of an XML signature based on the W3C standard for an existing wired environment are reduced and changed, a problem related to compatibility with existing wired environments is generated. In order to ensure compatibility between wired and wireless systems, services provided in existing wired environments must be corrected. Accordingly, a mobile XML signature method which is capable of resolving these problems is needed.

### SUMMARY OF THE INVENTION

The present invention provides a method and apparatus for providing an, extensible Markup Language (XML) signature service in a wireless environment.

The present invention also provides a mobile client supporting the provision of an XML signature service in a wireless environment.

The present invention also provides a method of verifying an XML signature in a wireless environment.

According to an aspect of the present invention, there is provided a mobile extensible Markup Language (XML) signature service providing apparatus comprising: an XML message analyzing unit authenticating a mobile client, according to an XML signature template generation request or an XML signature verification request received from the mobile client;
an XML signature processor generating an XML signature template and a SignedInfo element in a canonicalized format if the authentication is successful, and verifying an XML signature; and
an encoder providing key information and at least one setting value for the generation of the XML signature template and verification of the XML signature, to the XML signature processor.

According to another aspect of the present invention, there is provided a mobile client supporting a mobile XML signature service, comprising: a message transmitter generating an XML signature template generation request message including an option required for an XML signature, a resource to which the XML signature is applied, and information for mobile client authentication, and transmitting the XML signature template generation request message to a mobile XML signature service providing apparatus; a Signature unit receiving an XML signature template and a SignedInfo element in a canonicalized format from the XML signature service providing apparatus, performing a digital signature on the SignedInfo element, and inserting the signature result value into a SignatureValue element of the XML signature template; and an application interface unit outputting the XML signature to an application.service.

According to another aspect of the present invention, there is provided a mobile XML signature service providing method comprising: requesting an XML signature template from a mobile XML signature service providing apparatus, according to an option indicated by an application, in a mobile client; authenticating the mobile client, then accessing a resource to which an XML signature is applied, and generating and transmitting an XML signature template and a canonicalized SignedInfo element to the mobile client; and applying the digital signature on the SignedInfo element using a private key, and adding a digital signature value to the SignatureValue element in the XML signature template, in the mobile client.

According to another aspect of the present invention, there is provided A wireless XML signature verification method comprising: receiving an XML signature, generating a verification request message for the XML signature, and transmitting the verification request message to a wireless XML signature service providing apparatus, in a mobile client; authenticating the mobile client, verifying an XML signature based on a digest value and public key information, and transmitting the verification result to the mobile client, in the wireless XML signature service providing apparatus which receives the verification request message; and receiving the verification result and performing application-level processing based on the verification result, in the mobile client.

### BRIEF DESCRIPTION OF THE DRAWINGS

The above and other features and advantages of the present invention will become more apparent by describing in detail exemplary embodiments thereof with reference to the attached drawings in which:

FIG. 1 illustrates a configuration example of an application service for generating and verifying an extensible Markup Language (XML) signature in a wireless environment, using a mobile XML signature method according to an embodiment of the present invention;

FIG. 2A is a block diagram of a mobile XML signature trust service server according to an embodiment of the present invention;

FIG. 2B is a detailed block diagram of an XML signature processor illustrated in FIG. 2A;

FIG. 3 is a block diagram of a mobile client supporting a mobile XML signature trust service, according to an embodiment of the present invention;

FIG. 4 is a block diagram of a mobile XML signature trust service server according to another embodiment of the present invention;

FIG. 5 is a block diagram of a mobile client supporting the mobile XML signature trust service, according to another embodiment of the present invention;

FIG. 6 is a view for explaining a mobile XML signature generating service provided by the mobile XML signature trust service server according to an embodiment of the present invention;

FIG. 7 is a flowchart illustrating a mobile XML signature generating method according to an embodiment of the present invention;

FIG. 8 is a view for explaining a mobile XML signature verifying service provided by the mobile XML signature trust service server according to an embodiment of the present invention; and

FIG. 9 is a flowchart illustrating a mobile XML signature verifying method according to an embodiment of the present invention.

### DETAILED DESCRIPTION OF THE INVENTION

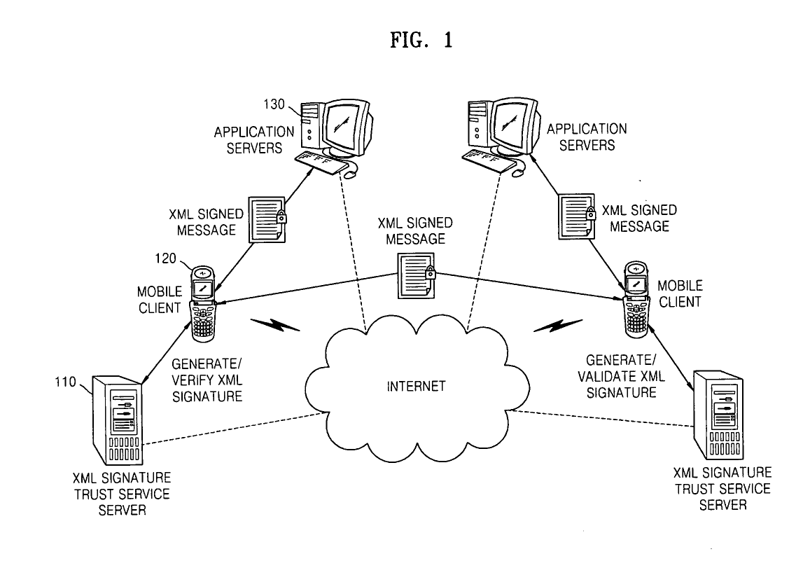

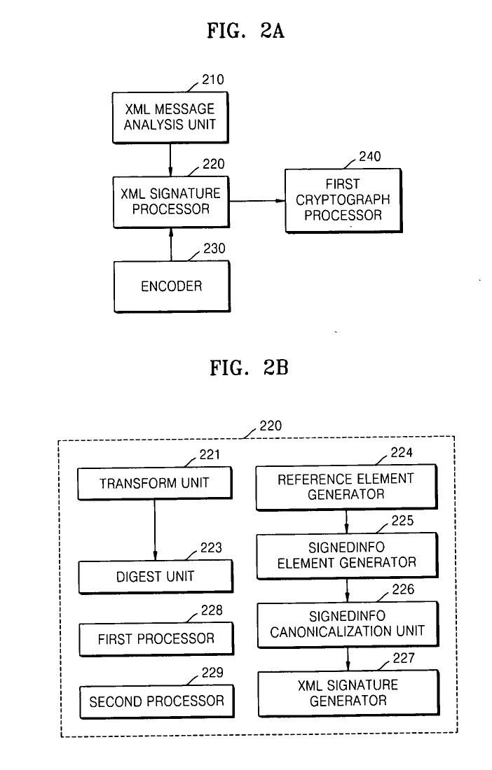

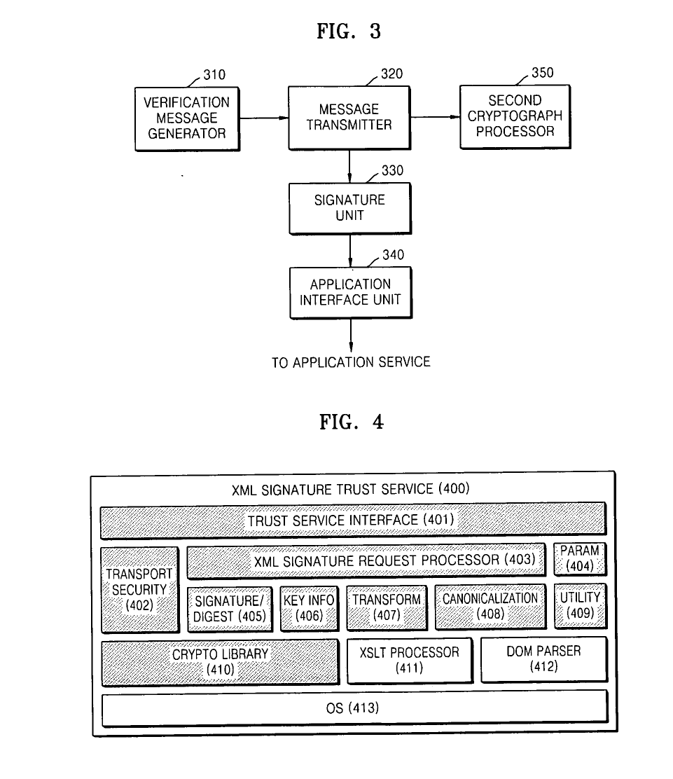

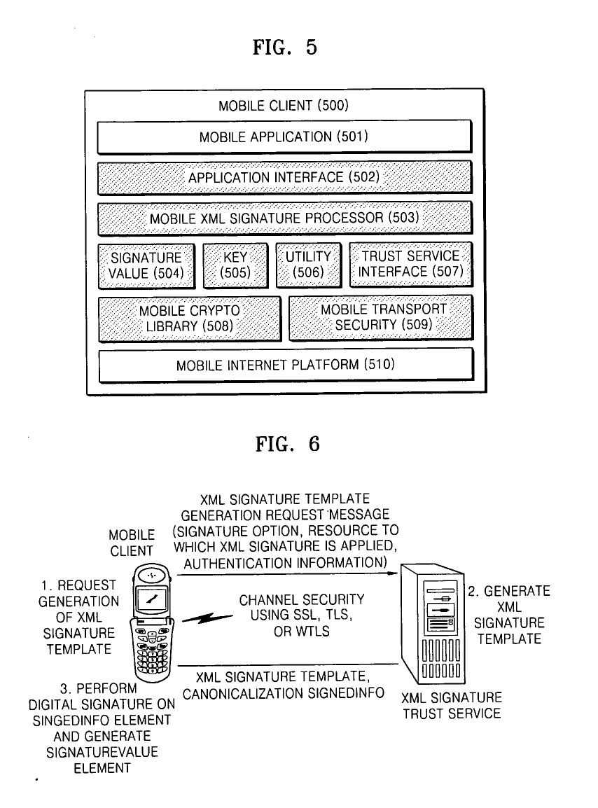

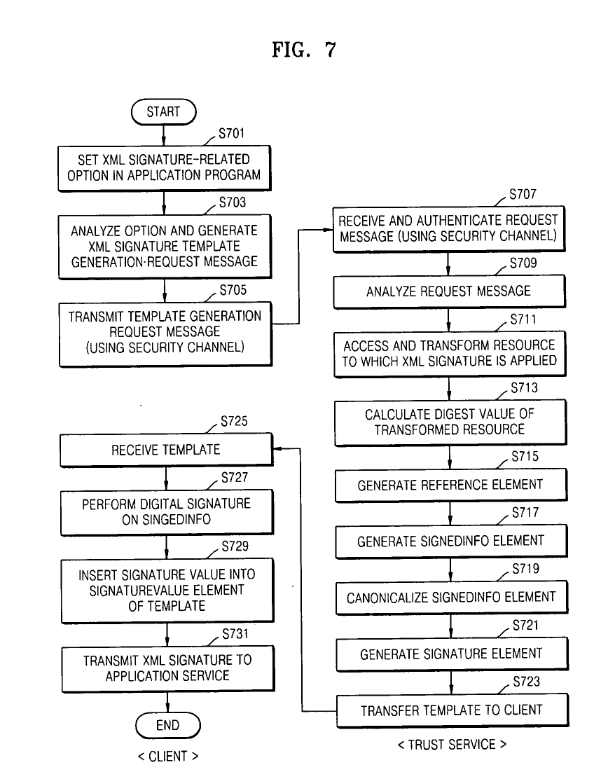

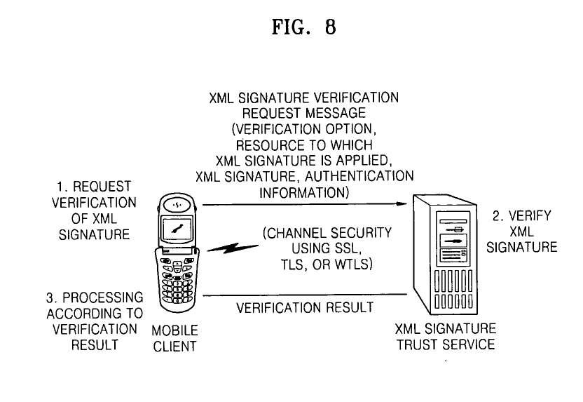

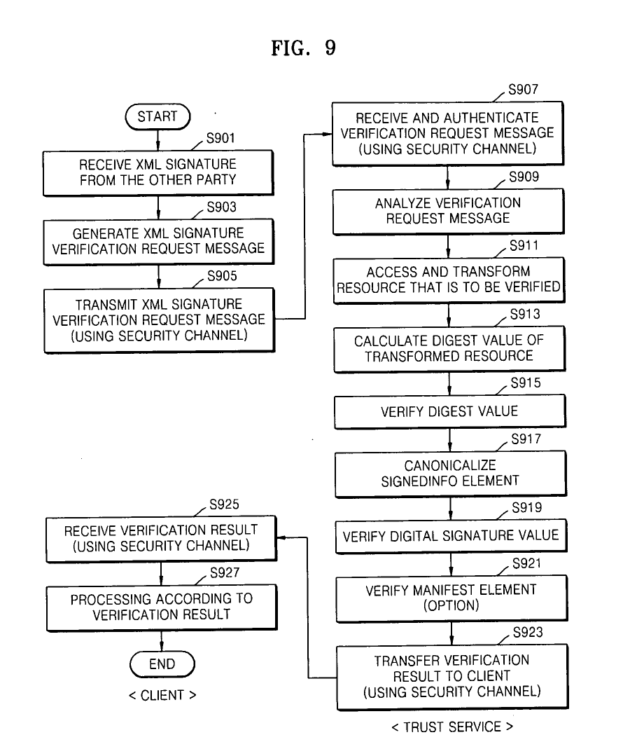

Hereinafter, embodiments of the present invention will be described in detail with reference to the appended drawings. FIG. 1 illustrates a configuration example of an application service for generating and verifying an eXtensible Markup Language (XML) signature in a wireless environment, using a mobile XML signature method according to an embodiment of the present invention. FIG. 2A is a block diagram of a mobile XML signature trust service server according to an embodiment of the present invention. FIG. 2B is a detailed block diagram of an XML signature processor 220 illustrated in FIG. 2A. FIG. 3 is a block diagram of a mobile client supporting a mobile XML signature trust service, according to an embodiment of the present invention. FIG. 4 is a block diagram of a mobile XML signature trust service server according to another embodiment of the present invention. FIG. 5 is a block diagram of a mobile client supporting the mobile XML signature trust service, according to another embodiment of the present invention. FIG. 6 is a view for explaining a mobile XML signature generating service provided by the mobile XML signature trust service server according to an embodiment of the present invention. FIG. 7 is a flowchart illustrating a mobile XML signature generating method according to an embodiment of the present invention. FIG. 8 is a view for explaining a mobile XML signature verifying service provided by the mobile XML signature trust service server according to an embodiment of the present invention. FIG. 9 is a flowchart illustrating a mobile XML signature verifying method according to an embodiment of the present invention.

Prior to describing the embodiments of the present invention, the need for the present invention will be schematically described below. Since mobile terminals used in wireless environments have many limitations in terms of resources, such as small memory capacity, slow processing speed, etc., they cannot perform all functions related to an XML signature. In order to resolve this problem, if functions of an existing XML signature are reduced and changed so they are suitable for wireless environments, a problem related to compatibility with existing wired environments is generated. In order to ensure compatibility between wired and wireless systems, services used in existing wired environments must be corrected. In order to resolve the problem, the present invention provides a reliable service which is called an “XML Signature Trust Service”. According to the XML signature trust service, when an XML signature based on the W3C standard is generated and verified, processing, such as XML parsing and transformation, etc. which use many resources is performed by an XML signature trust service server, and an XML signature method is performed by a mobile client, using a private key for a SignedInfo element. In embodiments of the present invention, it is assumed that the XML signature trust service can be trusted. However, if private keys are managed and an XML signature method is performed using the XML signature trust service server, private key outflow due to incidents, such as hacking of the XML Signature Trust Service server, etc., can occur. Accordingly, it is preferable that the XML Signature Trust Service server does not perform private key management. According to an embodiment of the present invention, since a mobile terminal generates a signature value using a private key and the private key is managed directly by the mobile terminal, a risk due to private key outflow can be eliminated.

According to an embodiment of the present invention, an XML signature generated by a mobile terminal can be verified by a different mobile terminal, or by a server or a client in an existing wired environment. Also, all XML signatures generated by a server or a mobile terminal in an existing wired environment can be verified by a different mobile client.

If the mobile XML signature as described above is applied, it is unnecessary to change services established under an existing wired environment even when a new mobile terminal is added to a service scenario. Also, since mobile terminals and wired clients are considered and processed as the same nodes logically when XML data is received/transmitted, all of the mobile terminals and wired clients can use the XML signature trust service without limitations.

Since the XML signature trust service according to the present invention is independent to specific applications, it is unnecessary to change the XML signature trust service according to the type of application service.

The mobile XML signature provides functions of authentication, integrity, and non-repudiation for XML messages, which are important elements in a wired-and wireless electronic commerce. The mobile XML signature can be used as an information protection module in various electronic commerce environments consisting of wired and wireless terminals.

Meanwhile, since the XML signature is a well-known technology based on the W3C standard, a detailed description thereof is omitted. Also, descriptions of transformation, XML canonicalization, etc. defined in the XML signature standard are omitted, and descriptions of specific element names (for example, a Reference element, SignedInfo element, KeyInfo element, SignatureValue element, Transform element, Manifest element, etc.) defined in the XML signature standard are also omitted. Also, descriptions of well-known XML-related technologies, such as XSLT, XPath, etc., are omitted.

1. Entire Service Configuration

FIG. 1 illustrates a configuration example of an application service for generating and verifying an XML signature in a wireless environment, using a mobile XML signature method according to an embodiment of the present invention.

Referring to FIG. 1, a mobile client (hereinafter referred to as a “mobile terminal”) 120 requests an XML signature trust service server 110 to generate an XML signature template, in order to generate an XML signature for an electronic document that is to be transmitted. The XML signature trust service server 110 accesses a resource according to settings designated by the mobile terminal 120, and performs parsing, XML canonicalization, digest processing, etc. on the resource, thereby generating an XML signature template including a SignedInfo element, etc. At this time, XML canonicalization is also performed on the SignedInfo element. The mobile client 120 receives an XML signature template and a canonicalized SignedInfo element, and applies digital signature to the canonicalized SignedInfo element using a private key, and inserts the resultant digital signature value to the SignatureValue element of the XML signature template, thereby generating an XML signature.

If the mobile terminal 120 receives the XML signature, the mobile terminal 120 transmits the XML signature to the XML signature trust service server 110 in order to request verification of the XML signature. The XML signature trust service server 110 verifies the XML signature according to settings requested by the mobile terminal 120 and informs the mobile terminal 120 of the verification result.

The generation of the XML signature and the verification of the XML signature can be performed by the same XML signature trust service or by different XML signature trust services. Also, it is unnecessary to change the XML signature trust service according to the type of application service.

Messages received or transmitted between the mobile client 120 and the XML signature trust service server 110 are protected by a communication channel security protocol, such as Wireless Transport Layer Security (WTLS), Secure Sockets Layer (SSL), or TLS.

Electronic documents received or transmitted between the mobile client 120 and the XML signature trust service server 110 are subjected to information protection services, such as authentication, integrity, non-repudiation, etc., through a mobile XML signature. In order to ensure network-level confidentiality when an electronic document subjected to a XML signature is transmitted to a receiver, the electronic document must be transmitted using a communication channel security protocol, such as WTLS, SSL, or TLS. According to the mobile XML signature generating and verifying service as described above, an XML signature generated by the mobile terminal 120 can be verified by a different mobile terminal, or by a server or a client in an existing wired environment. Also, all XML signatures generated by a server or a client in an existing wired environment can be verified by a different mobile client.

If the mobile XML signature is applied, it is unnecessary to change services established under an existing wired environment even when a new mobile terminal is added to a service scenario. Also, since the XML signature is compatible between wired and wireless environments, it is suitable for establishing electronic commerce services in a wired-and-wireless integrated environment. Also, since mobile terminals and wired clients are considered and processed as the same nodes logically when XML data is received/transmitted, all of the mobile terminals and wired clients can use the XML signature trust service transparenty.

Since the XML signature trust service according to the present invention is independent to specific applications, it is unnecessary to change the XML signature trust service according to the type of application service.

The mobile XML signature provides functions of authentication, integrity, and non-repudiation for XML messages, which are important elements in wired-and wireless electronic commerce. The mobile XML signature can be used as an information protection module in various electronic commerce environments consisting of wired and wireless terminals.

Application servers 130 illustrated in FIG. 1 provide services and perform an XML signature function in a wired environment. Since the XML signature function can be shared with the mobile client 120 without correction in existing services, a description therefor is omitted. That is, it is unnecessary to change existing services for application of the mobile XML signature.

2. XML Signature Trust Service Server and Mobile Client

FIGS. 2A, 2B, and 4 illustrate the structures of mobile XML signature trust service servers according to embodiments of the present invention. Referring to FIG. 2A, a mobile XML signature trust service server includes an XML message analysis unit 210, an XML signature processor 220, an encoder 230, and a first cryptograph processor 240. When the XML message analysis unit 210 receives an XML signature template generating request or an XML signature verifying request from a mobile client, the XML message analysis unit 210 authenticates the mobile client. If the XML message analysis unit 210 authenticates the mobile client successfully, the XML signature processor 220 generates an XML signature template and a SignedInfo element in a canonicalized format, or verifies an XML signature. The process will be described in more detail below with reference to FIG. 2B. The encoder 230 provides the XML signature processor 220 with setting values and key information required for generating the XML signature template and verifying the XML signature. The XML signature processor 220 will be described in detail later with reference to FIG. 4. The first cryptograph processor 240 applies at least one communication channel security protocol to messages and information received/transmitted from/to the mobile client.

The XML signature processor 220 will now be described in detail with reference to FIG. 2B. Referring to FIG. 2B, the XML signature processor 220 includes a transform unit 221, a digest unit 223, a reference element generator 224, a SignedInfo element generator 225, a SignedInfo canonicalization unit 226, and an XML signature generator 227. The XML signature processor 220 can be divided into a structure in which the mobile XML signature trust service server generates the XML signature template and a structure in which the mobile XML signature trust service server verifies the XML signature. In case of generating an XML signature, a digital signature value is not inserted into a SignatureValue element in the XML signature. The transform unit 221 accesses a resource to which the XML signature will be applied and transforms the resource. The digest unit 223 calculates and outputs a message digest value for the resource. The Reference element generator 224 generates a Reference element including a Uniform Resource Identifier (URI) of the resource, a name of the transform algorithm, a name of the digest algorithm, and the digest value. The SignedInfo element generator 225 generates a SignedInfo element including information about a canonicalization algorithm applied to the SignedInfo element, information about a digital signature algorithm which applies a digital signature to the SignedInfo element, and the Reference element. The SignedInfo canonicalization unit 226 canonicalizes the SignedInfo element according to the canonicalization algorithm designated in the SignedInfo element. The XML signature generator 227 generates a Signature element which is an upper most element of the XML signature. By carrying out these processes, an XML signature template is finally generated.

A case where the mobile XML signature trust service server verifies an XML signature will now be described. In this case, the XML signature processor 220 further includes a first processor 228 for accessing a resource based on information included in a Reference element in a SignedInfo element of an XML signature received from a mobile client, transforming the resource, calculating a digest value of the resources, and comparing the digest value with a digest value in the Reference element; and a second processor 229 for canonicalizing the SignedInfo element, reading public key information from the encoder 230, and verifying an XML signature value for the canonicalized SignedInfo element.

Hereinafter, the construction of the mobile client 120 illustrated in FIG. 1 will be described in detail with reference to FIG. 3. The mobile client 120 supports the mobile XML signature function according to an embodiment of the present invention, as well as general mobile terminal functions. Referring to FIG. 3, the mobile client 120 includes a message transmitter 320, a second cryptograph processor 350, a Signature unit 330, and an application interface unit 340. The message transmitter 320 generates an XML signature template generation request message including an option required for an XML signature, a resource to which an XML signature will be applied, and information for mobile client authentication, and transfers the XML signature template generation request to the second cryptograph processor 350 which applies at least one communication channel security protocol to messages and information received/transmitted from/to the mobile client 120. The second cryptograph processor 350 transmits the XML signature template generation request to the mobile XML signature trust service server 110 illustrated in FIG. 1.

The Signature unit 330 receives an XML signature template and a SignedInfo element in a canonicalized format from the mobile XML signature trust service server 110, applies a digital signature to the SignedInfo element, and inserts the resultant signature value into a SignatureValue element of the XML signature template.

The application interface unit 340 outputs a complete XML signature to an application service (that is, an application software), so as to receive and transmit data from/to an application server 130.

Meanwhile, in the case where an XML signature verification request is issued from a different mobile client, the mobile client 120 further includes a verification message generator 310 for generating and outputting an XML verification request message including an option required for verification, an XML signature that is to be verified, a resource to which an XML signature will be applied, and authentication information.

Hereinafter, an XML signature trust service server 400 according to another embodiment of the present invention will be described with reference to FIG. 4. Referring to FIG. 4, the XML signature trust service server 400 includes a trust service interface module 401, an XML signature request processor module 403, a Param module 404, a signature/digest module 405, a KeyInfo module 406, a transform module 407, a canonicalization module 408, a utility module 409, a transport security module 402, and a crypto library module 410.

The trust service interface module 401 performs a communication-related function of receiving an XML signature generation/verification request of the mobile client 120 from the mobile client 120 illustrated in FIG. 1, and transferring a response to the request to the XML signature request processor module 403.

The XML Signature Request Processor module 403 analyzes the XML signature generation/verification request of the mobile client 120 in order to extract a signature/verification-related parameter from the XML signature generation/verification request, and calls lower modules using the signature/verification-related parameter so as to generate an XML signature template or verify an XML signature.

The Param module 404 includes objects for storing setting values related to the generation and verification of the XML signature.

The signature/digest module 405 performs generation/verification of digest values and verification of digital signature values. The generation of digital signature values is performed by the mobile client 120.

The KeyInfo module 406 encodes/decodes key information, such as certification, public keys, etc., in a format required for the XML signature.

The transform module 407 performs transformation, such as XPath Transformation and XSLT Transformation, as defined in the XML signature standard.

The canonicalization module 408 performs XML canonicalization, exclusive canonicalization, etc., as defined in the XML signature standard.

The utility module 409 stores functions which several modules share with respect to the XML signature trust service server 400.

The transport security module 402 provides network-level security for communication between the mobile client 120 and the XML signature trust service server 400, and provides a communication channel security protocol, such as WTLS, SSL, or TLS.

The crypto library module 410 provides a crypto library for cryptograph-related processing such as a cryptograph algorithm and cryptograph key processing.

The XML signature trust service server 400 can further include an XSLT processor 411, a document object model (DOM) parser 412, and an OS 413. The eXtensible Stylesheet Language Transformations (XSLT) processor 411 supports a function such as XPath and XSLT, and the DOM Parser 412 is used to process XML documents in a DOM format.

FIG. 5 is a block diagram of a mobile client 500 supporting the mobile XML signature trust service, according to another embodiment of the present invention.

Referring to FIG. 5, the mobile client 500 includes an application interface module 502, a mobile XML signature processor module 503, a signature value module 504, a key module 505, a utility module 506, a trust service interface module 507, a mobile crypto library module 508, and a mobile transport security module 509.

The application interface module 502 functions as an interface for receiving parameters related to the generation or verification of an XML signature from a mobile application. XML signature processing is performed based on the parameters received from the application interface module 502. The application interface module 502 functions as an Application Program Interface (API) for a mobile application developer, and the application developer can only call the API to perform XML signature processing in a desired format.

The mobile XML signature processor module 503 receives the parameters set by the application interface module 501, calls different lower modules, and performs generation and verification of an XML signature.

The signature value module 504 generates a digital signature value for a canonicalized SignedInfo element received from a XML signature trust service server, and inserts the digital signature value into a SignatureValue element in an XML signature template.

The key module 505 reads and processes a cryptograph key.

The utility module 506 provides functions required by respective modules of the mobile client 500.

The trust service interface module 507 provides an interface for communicating with the XML signature trust service server. The generation and verification of an XML signature template are requested and the result is received, by means of the trust service interface module 507.

The mobile transport security module 509 provides network-level security for communication between the mobile client 500 and the XML signature trust service server, and a communication channel security protocol, such as SSL, WTLS, and TLS, is implemented so as to be suitable for the corresponding mobile environment.

The mobile crypto library module 508 performs cryptograph-related processing such as a cryptograph algorithm and cryptograph key processing, and is implemented so as to be suitable for the corresponding mobile environment.

3. The Structure and Processing Procedure of a Mobile XML Signature Generating Service

FIG. 6 is a view for explaining a mobile XML signature generating service provided by the mobile XML signature trust service server according to an embodiment of the present invention.

Referring to FIG. 6, a mobile client transmits a template generation request message, requesting the generation of an XML signature template, to the XML signature trust service server, in order to generate an XML signature for an electronic document that is to be transmitted. Here, the template generation request message includes settings (algorithms that are to be used, a key-related option, etc.) related to the XML signature, a resource to which the XML signature will be applied, authentication information for using the XML signature trust service server, etc., wherein the resource to which the XML signature will be applied can be transmitted as it is, or only a UR can be transmitted if the resource can be accessed in a remote site.

If the XML signature trust service server receives the template generation request message from the mobile terminal, the XML signature trust service server authenticates the mobile terminal, accesses a resource according to a designated setting condition, performs parsing, transformation, and digest processing on the resource, and generates an XML signature template including a SignedInfo element, etc. At this time, XML canonicalization is also performed on the SignedInfo element. The XML signature template has a structure in which no digital signature value is included in a SignatureValue element of a general XML signature. An XML signature value is later inserted into the XML signature template by a client part.

The XML signature template is transferred to the mobile client. At this time, a SignedInfo element in a canonicalized format is also transferred to the mobile client.

The mobile client performs a digital signature on the canonicalized SignedInfo element, using its own private key, and inserts the digital signature value to the SignatureValue element of the XML signature template, thereby completing the generation of an XML signature.

Messages transmitted/received between the mobile client and the XML signature trust service server are protected by a communication channel security protocol, such as TLS, SSL, or WTLS.

FIG. 7 is a flowchart illustrating a mobile XML signature generating method according to an embodiment of the present invention.

Referring to FIG. 7, if a mobile application program sets an XML signature-related option in operation S701, a mobile client analyzes settings of the XML signature-related option and generates an XML signature template generation request message for the XML signature trust service server. The XML signature template generation request message includes settings (algorithms to be used, a key-related option, etc.) related to an XML signature, a resource to which an XML signature will be applied, authentication information for using the XML signature trust service server, etc., wherein the resource to which the XML signature will be applied can be transmitted as it is, or only a UR can be transmitted if the resource can be accessed in a remote site in operation S703.

The mobile client transmits the XML signature template generation request message to the XML signature trust service server. When the XML signature template generation request message is transmitted, a communication channel security protocol, such as TLS, SSL, or WTLS, is used for message protection. Since the communication channel security protocol includes server authentication, the mobile client authenticates the XML signature trust service server. For mobile client authentication, an ID, a password, a certification, etc. can be transmitted. Also, it is possible to authenticate the mobile client using a mobile client authentication option such as SSL or TLS in operation S705.

The XML signature trust service server receives an XML signature template generation request message from the mobile client through a security channel, and authenticates the mobile client in operation S707.

The XML signature trust service server analyzes the XML signature template generation request message in operation S709, and generates an XML signature template according to a set option.

First, the XML signature trust service server accesses a resource to which an XML signature will be applied, and appropriately transforms the resource, using a transform algorithm such as XML Canonicalization, Base64 Transform, XPath Transform, etc. in operation S711.

Then, a message digest is performed on the transformed resource, and a “Reference” element including a URI for a signature object, a name of the used transform algorithm, a name of the digest algorithm, and the digest value is generated in operation 713. When an XML signature is applied simultaneously to a plurality of resources, Reference elements for the respective resources are directly included in “SignedInfo” elements or “Manifest” elements. If the reference elements are included in the Manifest elements, a Reference element for each Manifest element is generated and included in a SignedInfo structure in operation S715.

Then, a SignedInfo element is generated. The SignedInfo element includes a Canonicalization-Method element containing information about a canonicalization algorithm that is to be applied, a SignatureMethod element containing information about an XML signature algorithm which performs a digital signature on the SignedInfo element, a Reference element for a Manifest element (if used), a Reference element for other resource, etc. in operation S717.

Then, canonicalization of the SignedInfo element is performed using a canonicalization algorithm designated in the Canonicalization-Method element in operation S719.

Next, a Signature element, which is an upper most element of an XML signature, is generated. The signature element includes various additional information, such as a SignedInfo element, a SignatureValue element that will include a digital signature value for the SignedInfo element, a Keyinfo element including signatory's key information, and an Object element including a Manifest element (if used), etc. In the case of the mobile XML signature, since the generation of the digital signature value is performed by a mobile client, the SignatureValue element does not include a signature value in operation S721.

The XML signature trust service server transfers the XML signature template generated by the above-described processes from operations S701 to S721 and the SignedInfo element in a canonicalized format to the mobile client. Messages received/transmitted between the mobile client and the XML signature trust service server are protected by a communication channel security protocol such as TLS, SSL, or WTLS in operation S723.

The mobile client receives the XML signature template and the canonicalized SignedInfo element through a security channel in operation S725.

Then, the mobile client performs a digital signature on the canonicalized SignedInfo element in operation S727.

Then, the mobile client inserts the signature result value into the SignatureValue element in the XML signature template in operation S729.

The process of generating XML signature is performed by the above-described processes from operations S701 to S721, and the mobile client transfers the XML signature to the application service in operation S731.

By generating an XML signature with the XML format and transmitting a message together with the XML signature, as described above, authentication, integrity, and non-repudiation of the message are ensured. Additionally, it is possible to ensure network-level confidentiality by applying a separate XML cryptograph module or using TLS provided by a mobile XML signature package.

4. Construction and Processing of the Mobile XML Signature Verification Service

FIG. 8 is a view for explaining a mobile XML signature verification service provided by the mobile XML signature trust service server according to an embodiment of the present invention.

Referring to FIG. 8, if a mobile client receives an XML signature, the mobile client generates an XML signature verification request message, and transmits the XML signature verification request message to the XML signature trust service server. The XML signature verification request message includes a resource to which an XML signature verification will be applied, an XML signature that is to be verified, authentication information for using the XML signature trust service server, etc., wherein the resource can be transmitted in its original form, or only a URI can be transmitted if the resource can be accessed in a remote site.

The XML signature trust service server receives a verification request message, then authenticates the mobile client, verifies the XML signature according to settings requested by the mobile client, and informs the mobile client of the verification result. A general XML signature verification procedure can be used to perform this operation.

Messages received/transmitted between the mobile client and the XML signature trust service server are protected by a communication channel security protocol, such as TLS, SSL, or WTLS.

FIG. 9 is a flowchart illustrating a mobile XML signature verifying method according to an embodiment of the present invention.

Referring to FIG. 9, the mobile XML signature verification method is similar to a general XML signature verification method, except for the fact that if a mobile client transmits an XML signature to an XML signature trust service server and requests verification of the XML signature, the XML signature trust service server performs the verification of the XML signature and informs the mobile client of the verification result. The mobile XML signature verification method will now be described in detail with reference to FIG. 9.

If a mobile client receives an XML signature in operation S901, the mobile client generates an XML signature verification request message. The XML signature verification request message includes an option (information about whether a Manifest element has to be verified, public key information as necessary, etc.) required for XML signature verification, a resource to which an XML signature verification will be applied, an XML signature that is to be verified, authentication information for using the XML signature trust service server, etc., wherein the resource can be transmitted in its original form, or only a URI can be transmitted if the resource can be accessed in a remote site in operation S903.

The mobile client transmits the XML signature verification request message to the XML signature trust service server. When the XML signature verification request message is transmitted, a communication channel security protocol, such as TLS, SSL, or WTLS, is used for message protection. Since the communication channel security protocol includes server authentication, the mobile client authenticates the XML signature trust service server. Here, it is possible to transmit an ID, a password, a certification, etc. for client authentication. Also, it is possible to authenticate the mobile client using a client authentication option of SSL or TLS in operation S905.

The XML signature trust service server receives the XML signature verification request message from the mobile client through a security channel, and authenticates the mobile client in operation S907.

The XML signature trust service server analyzes the verification request message in operation S909 and verifies an XML signature according to a set option, as follows.

First, a resource that is to be verified is accessed using URI information of a Reference element included in a SignedInfo element of the XML signature. The resource is transformed using a transform method designated in the Reference element in operation S911.

A digest value for the transformed resource is calculated using a digest algorithm designated in the Reference element in operation S913.

Then, it is determined whether the calculated digest value is equal to a digest value included in the corresponding Reference element. Due to characteristics of the message digest algorithm, when the corresponding resource changes, a message digest value for an original copy in the Reference element is made to differ from a message digest value of the transformed resource. The difference indicates whether data changes. All reference values are verified in this manner in operation S915.

Then, the SignedInfo element is canonicalized using a canonicalization method designated in a Canonicalization-Method element in the SignedInfo element in operation S917.

Public key information is received from the KeyInfo element for signature verification, and the digital signature value for the canolicalized SignedInfo element is verified using the public key information and a signature algorithm defined in the SignatureMethod element in operation S919.

If the mobile client requests verification of a Manifest element, verification of the Manifest element is performed. In order to verify the Manifest element, respective elements included in the Manifest element are verified using the Reference element verification method as described above in operation S921.

If verification is successful in operations S901 through S919 (or S921), it means that XML signature verification is successful. The XML signature trust service server transmits the XML signature verification result to the mobile client. Here, messages received/transmitted between the mobile client and the XML signature trust service server are protected using a communication channel security protocol, such as TLS, SSL, and WTLS in operation S923.

The mobile client receives the XML signature verification result through a security channel in operation S925.

The mobile client performs appropriate application-level processing according to the XML signature verification result in operation S927.

The verified XML signature ensures that the respective resources are not changed, and provides transmitter authentication and transmitter non-repudiation.

The present invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion.

As described above, in a mobile XML signature service providing apparatus and method according to the present invention, it is unnecessary to change services established in an existing wired environment even when a new mobile client is added to a service scenario. Also, in the mobile XML signature service providing apparatus and method, since an XML signature is compatible between wired and wireless environments, the mobile XML signature service providing apparatus and method are suitable for establishing an electronic commerce service in a wired-and-wireless integrated environment. Also, since mobile terminals and wired clients are considered and processed as the same nodes logically when XML data is received/transmitted, all of the mobile terminals and wired clients can use the XML signature trust service transparently.

Since the XML signature trust service according to the present invention is independent to specific applications, it is unnecessary to change the XML signature trust service according to the type of application service.

A mobile XML signature according to the present invention provides functions of authentication, integrity, and non-repudiation with respect to XML messages, which are important in a wired and wireless electronic commerce, and can be used as an information prevention module in various electronic commerce environments consisting of wired and wireless terminals.

Also, the XML signature according to the present invention provides authentication, integrity, non-repudiation, etc. with respect to messages received/transmitted in a wireless environment, can be applied to a wireless environment having limited resources, can be compatible with an existing XML signature in a wired environment that is to be applied to wired-and-wireless integrated electronic commerce, and minimizes a change in an existing wired environment when the XML signature is applied.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A mobile extensible Markup Language (XML) signature service providing apparatus comprising:
an XML message analyzing unit authenticating a mobile client, according to an XML signature template generation request or an XML signature verification request received from the mobile client;
an XML signature processor generating an XML signature template and a SignedInfo element in a canonicalized format if the authentication is successful, and verifying an XML signature; and
an encoder providing key information and at least one setting value for the generation of the XML signature template and verification of the XML signature, to the XML signature processor.

2. The apparatus of claim 1, further comprising a first cryptograph processor applying at least one communication channel security protocol to a message and information received/transmitted from/to the mobile client.

3. The apparatus of claim 1, wherein the XML signature processor does not insert a digital signature value into the SignatureValue element in the XML signature, when the XML signature template is generated.

4. The apparatus of claim 1, wherein, when the mobile XML signature service providing apparatus generates the XML signature templates the XML signature processor comprises:
a transform unit accessing a resource to which the XML signature is applied and transforming the resource;
a digest unit calculating and outputting a message digest value for the transformed resource;
a Reference element generator unit generating a Reference element including a Uniform Resource Identifier (URI) of the resource, a name of a transform algorithm, a name of a digest algorithm, and a digest value;
a SignedInfo element generator unit generating a SignedInfo element including information about a canonicalization algorithm applied to the SignedInfo element, information about a digital signature algorithm applied to the SignedInfo element, and the Reference element;
a SignedInfo canonicalization unit canonicalizing the SignedInfo element based on a canonicalization algorithm designated in the SignedInfo element; and
an XML signature generator unit generating a Signature element which is an upper most element of the XML signature.

5. The apparatus of claim 1, wherein, when the mobile XML signature service providing apparatus authenticates the XML signature, the XML signature processor comprises:
a first processor accessing and transforming a resource based on information provided by a Reference element in a SignedInfo element of an XML signature, calculating a digest value of the resource, and comparing the digest value with a digest value included in the Reference element; and
a second processor canonicalizing the SignedInfo element, reading public key information from the encoder, and verifying an XML signature value for the canonicalized SignedInfo element.

6. A mobile client supporting a mobile XML signature service, comprising:
a message transmitter generating an XML signature template generation request message including an option required for an XML signature, a resource to which the XML signature is applied, and information for mobile client authentication, and transmitting the XML signature template generation request message to a mobile XML signature service providing apparatus;
a Signature unit receiving an XML signature template and a SignedInfo element in a canonicalized format from the XML signature service providing apparatus, performing a digital signature on the SignedInfo element, and inserting the signature result value into a SignatureValue element of the XML signature template; and
an application interface unit outputting the XML signature to an application.service.

7. The mobile client of claim 6, further comprising a verification message generating unit generating and outputting an XML signature verification request message including an option required for verification, a resource to which an XML signature verification is applied, an XML signature that is to be verified, and authentication information, when an XML signature verification request is issued from a different mobile client.

8. The mobile client of claim 6, further comprising a second cryptograph processor applying at least one communication channel security protocol to a message and information received/transmitted from/to the mobile client.

9. A mobile XML signature service providing method comprising:
(a) requesting an XML signature template from a mobile XML signature service providing apparatus, according to an option indicated by an application, in a mobile client;
(b) authenticating the mobile client, then accessing a resource to which an XML signature is applied, and generating and transmitting an XML signature template and a canonicalized SignedInfo element to the mobile client; and
(c) Applying the digital signature on the SignedInfo element using a private key, and inserting a digital signature value to the SignatureValue element in the XML signature template, in the mobile client.

10. The method of claim 9, wherein in operation (a) an XML signature template generation request message including an option required for the XML signature, a resource to which the XML signature is applied, and information for mobile client authentication are generated.

11. The method of claim 9, wherein operation (b) comprises:
(b1) authenticating the mobile client;
(b2) if the authentication is successful, accessing and transforming the resource, and generating a digest value of the resource;
(b3) generating a plurality of elements required for generating the XML signature template; and
(b4) transmitting the XML signature template and the canonicalized SignedInfo element to the mobile client.

12. The method of claim 11, wherein operation (b2) comprises:
(b21) transforming the resource; and
(b22) performing message digest on the resource.

13. The method of claim 11, wherein operation (b3) comprises:
(b31) generating a Reference element including a URI of the resource, a name of a transform algorithm, a name of a digest algorithm, and a digest value;
(b32) generating a SignedInfo element including information about a canonicalization algorithm applied to the SignedInfo element, information about a digital signature algorithm applied to the SignedInfo element, and the Reference element.
(b33) canonicalizing the SignedInfo element based on a canonicalization algorithm applied to the SignedInfo element; and
(b34) generating a Signature element which is an upper most element of the XML signature.

14. The method of claim 9, wherein, if the XML signature is performed simultaneously on a plurality of resources, a Reference element for each resource is included in a SignedInfo element or in a Manifest element.

15. The method of claim 13, wherein, in operation (b34), the Signature element includes the SignedInfo element, a SignatureValue element, a KeyInfo element, and a Manifest element.

16. The method of claim 15, wherein the SignatureValue element does not includes a signature value.

17. A wireless XML signature verification method comprising:
(a) receiving an XML signature, generating a verification request message for the XML signature, and transmitting the verification request message to a wireless XML signature service providing apparatus, in a mobile client;
(b) authenticating the mobile client, verifying an XML signature based on a digest value and public key information, and transmitting the verification result to the mobile client, in the wireless XML signature service providing apparatus which receives the verification request message; and
(c) receiving the verification result and performing application-level processing based on the verification result, in the mobile.

18. The method of claim 17, wherein, in operation (a), the mobile client comprises generating an XML signature verification request message including information about whether a Manifest element has been verified, public key information, a resource to which the XML signature is applied, an XML signature that is to be verified, and authentication information.

19. The method of claim 17, wherein operation (b) comprises:
(b1) calculating a digest value of the resource, and determining whether the digest value is equal to a digest value included in a Reference element for the resource, thereby verifying whether data has been changed;
(b2) canonicalizing a SignedInfo element; and
(b3) reading public key information from a Keyinfo element, and verifying a digital signature value for the canonicalized SignedInfo element using a signature algorithm designated in the SignatureMethod element.

20. The method of claim 19, further comprising, if the mobile client requests verification of the Manifest element, verifying the Manifest element by applying operations (b1), (b2), and (b3) to each Reference element included in the Manifest element.
